(19) United States
(12) Patent Application Publication
(10) Pub. No.: US 2018/0132512 A1
(43) Pub. Date: May 17, 2018

(54) SHELF-STABLE EGG-BASED PRODUCT AND METHODS AND SYSTEMS FOR MAKING THEREOF

(71) Applicant: Lawless Jerky, Phoenix, AZ (US)

(72) Inventors: Matthew Tolnick, Phoenix, AZ (US); Sharat Chandra Jonnalagadda, Belmont, MA (US); Adam Jacob Maxwell, Watertown, MA (US); Leslie D. Morgret, Northborough, MA (US); Theodore Fagan, Ipswich, MA (US)

(21) Appl. No.: 15/713,680

(22) Filed: Sep. 24, 2017

Related U.S. Application Data
(60) Provisional application No. 62/400,417, filed on Sep. 27, 2016.

(51) Int. Cl. A23L 15/00; A23B 5/005

(52) U.S. Cl. CPC A23L 15/20; A23V 2002/00; A23B 5/0057; A23L 15/30

(57) ABSTRACT

A method for manufacturing a shelf-stable food product is provided. The method may include providing an egg base, providing a hydrocolloid set, providing a fat, homogenizing the egg base with at least the hydrocolloid set and the fat into a batter, sealing a batter portion of the batter into a container, and heating the container. The egg base may have a first ratio of egg white solids to egg yolk solids within a range of 2.25:1 and 4.75:1. A shelf-stable food product made by disclosed methods is also provided. The shelf-stable food product may be enclosed with heat resistant packaging.

This application claims priority to, and incorporates herein in its entirety, U.S. Provisional Patent Application 62/400,417, filed Sep. 27, 2016.

### TECHNICAL FIELD

This application relates to shelf-stable food products, and methods and systems of manufacture thereof. More specifically, this application relates to egg-based shelf-stable food products.

### BACKGROUND

Snack foods, like potato chips and candy, provide consumers with shelf-stable foods that can conveniently be eaten “on the run” and typically without any preparation or wait time. However, commonly consumed snack foods are often unhealthy or otherwise lacking in nutrition, and may be characterized as containing large amounts of carbohydrates, preservatives, fat, and/or other ingredients that are undesirable for the health-conscious snack consumer. Current snack choices are also somewhat limited for consumers with diets that seek to avoid or reduce carbohydrate or gluten intake. Although the snack food market is replete with shelf-stable high-protein and/or healthier snack foods, such as dried fruits, nuts, and beef jerky, certain health-conscious snack consumers desire a food product that may be viewed an as a meal replacement with respect to flavor, ingredients, and/or nutrient content, but still has the convenience of a snack food.

### SUMMARY

The present disclosure provides a description of shelf-stable food products that may address the perceived need described above, as well as methods and systems for making the same.

In one embodiment, a method for manufacturing a shelf-stable food product is provided. The method may include providing an egg base, providing a hydrocolloid set, providing a fat, homogenizing the egg base with at least the hydrocolloid set and the fat into a batter, sealing a batter portion of the batter into a container, and heating the container. The egg base may have a first ratio of egg white solids to egg yolk solids within a range of 2.25:1 and 4.75:1.

The step of homogenizing may further include homogenizing the batter to a viscosity of between 1,000 cP and 200,000 cP.

The method may further include a step of adding a first inclusion to the batter after the homogenizing step. The method may further include a step of providing a plurality of pieces of cheese as the first inclusion. At least one piece of cheese with a size of a 1 mm or greater in each of three spatial dimensions may be provided.

The step of heating the container may include retorting the container at a pressure between 24.7 and 45 psi at a temperature of between 109° C. and 130° C. for 15-100 minutes. The step of sealing a batter portion of the batter into a container may include a step of providing at least 50% of head space by volume within the container. The step of providing a hydrocolloid set may include providing a portion of Xanthan gum at between 0.15% and 2.0% of the batter portion by weight.

The method may further include a step of acidulating the batter to a pH of between 4.0 and 4.6 using at least one of gluconic acid, gluconodelta-lactone, and lactic acid. The step of heating the container may include heating the container at a temperature between 90° C. and 100° C. for between 30 minutes and an hour. The step of providing a hydrocolloid set may further include providing a portion of konjac flour at between 0.25% and 5.0% of the batter portion by weight, and providing a portion of guar gum at between 0.25% and 3.0% of the batter portion by weight.

The step of providing a fat may further include providing a portion of saturated fat at between 5% and 25% of the batter portion by weight.

The method may further include a step of providing a portion of encapsulated baking powder and adding the portion into the batter after homogenizing the batter. The portion of encapsulated baking powder may be between 0.5% and 3.0% of the batter portion by weight.

In another embodiment, a shelf-stable food product prepared by any of the above-described processes may be provided.

In yet another embodiment, a shelf-stable food product is provided. The shelf-stable food product may include an egg base, a hydrocolloid set, and a fat. The egg base may have a first ratio of egg white solids to egg yolk solids between 2.25:1 and 4.75:1. The shelf-stable food product may be enclosed within heat resistant packaging.

The fat may be a saturated fat at between 5% and 25% of the shelf-stable food product by weight.

The shelf-stable food product may have a bulk density of between 0.42 g/cc and 1.1 g/cc. The shelf-stable food product may have moisture content of between 55% and 75%. The shelf-stable food product may further include a plurality of pocketed cheese domains.

The hydrocolloid set may include a portion of konjac flour at between 0.25% and 5.0% of the batter portion by weight, and a portion of guar gum at between 0.25% and 3.0% of the shelf-stable food product by weight.

The shelf-stable food product may have a water activity level of between 0.92 AW and 0.98 AW and a pH level of between 3.9 and 4.6. The hydrocolloid set may include a portion of Xanthan gum at between 0.15% and 2.0% of the shelf-stable food product by weight.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated into and constitute a part of this disclosure, illustrate several embodiments and aspects of the food products, systems, and methods described herein and, together with the description, serve to explain the principles of the invention.

FIGS. 1A and 1B are photos of a version of a shelf-stable egg-based food product manufactured using a retort technique, consistent with disclosed embodiments.

FIGS. 1C and 1D are photos of another version of a shelf-stable egg-based food product manufactured using a retort technique, consistent with disclosed embodiments.

FIGS. 2A and 2B are photos of a version of a shelf-stable egg-based food product manufactured using a high acid pasteurization technique, consistent with disclosed embodiments.

FIGS. 2C and 2D are photos of another version of a shelf-stable egg-based food product manufactured using a high acid pasteurization technique, consistent with disclosed embodiments.

FIG. 3A is a flow chart of an example of a method of manufacturing a shelf-stable egg-based food product using a retort technique, consistent with disclosed embodiments.

FIG. 3B is a flow diagram of an example of a method of manufacturing a shelf-stable egg-based food product using a retort technique, consistent with disclosed embodiments.

FIG. 4A is a flow chart of an example of a method of manufacturing a shelf-stable egg-based food product using a high acid pasteurization technique, consistent with disclosed embodiments.

FIG. 4B is a flow diagram of an example of a method of manufacturing a shelf-stable egg-based food product using a high acid pasteurization technique, consistent with disclosed embodiments.

FIGS. 5A and 5B are photos of a shelf-stable egg-based food product manufactured using a baking or smoking method, consistent with disclosed embodiments.

FIG. 6 is a flow chart of an example of a method of manufacturing a shelf-stable egg-based food product using a baking or smoking method, consistent with disclosed embodiments.

FIGS. 7A-7C are illustrations and assessments of exemplary packaging elements for use with shelf-stable egg-based foods, consistent with disclosed embodiments.

### DETAILED DESCRIPTION

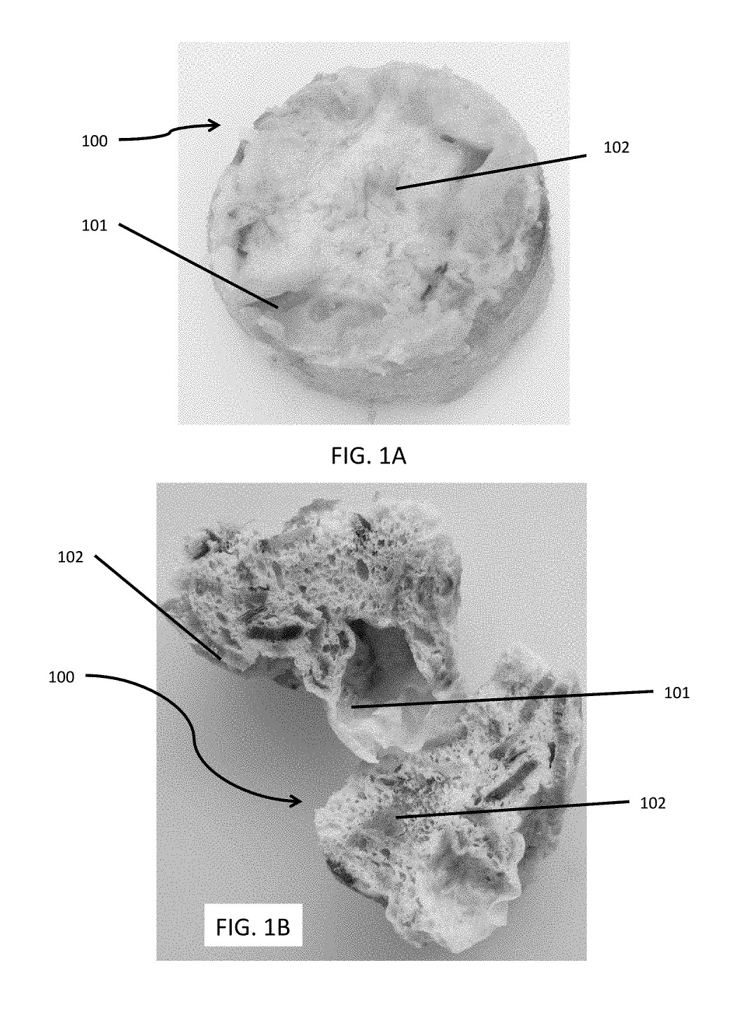

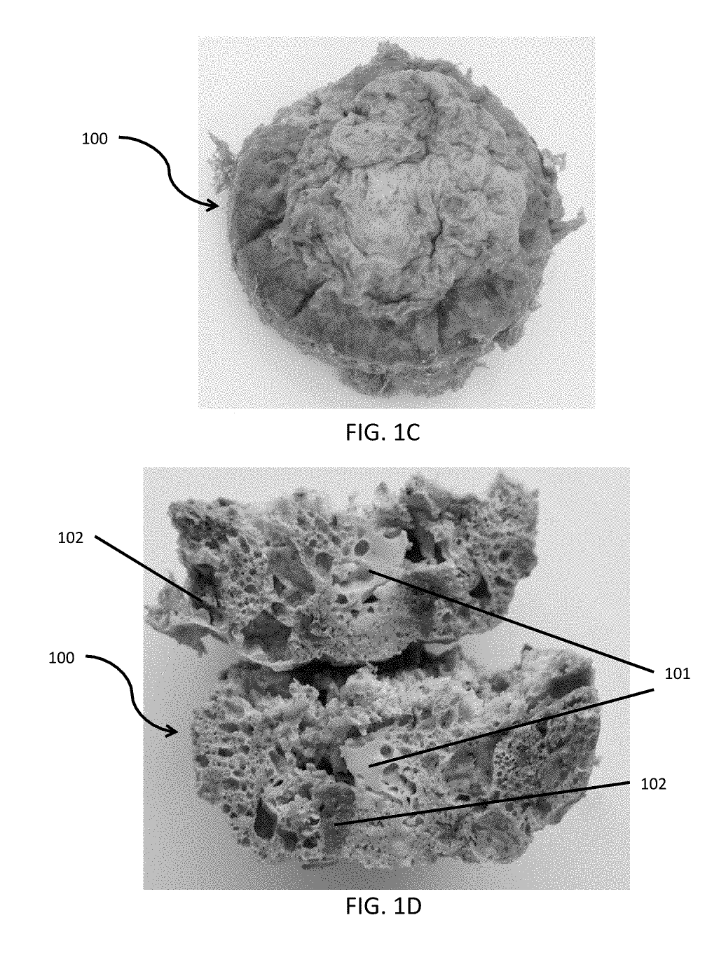

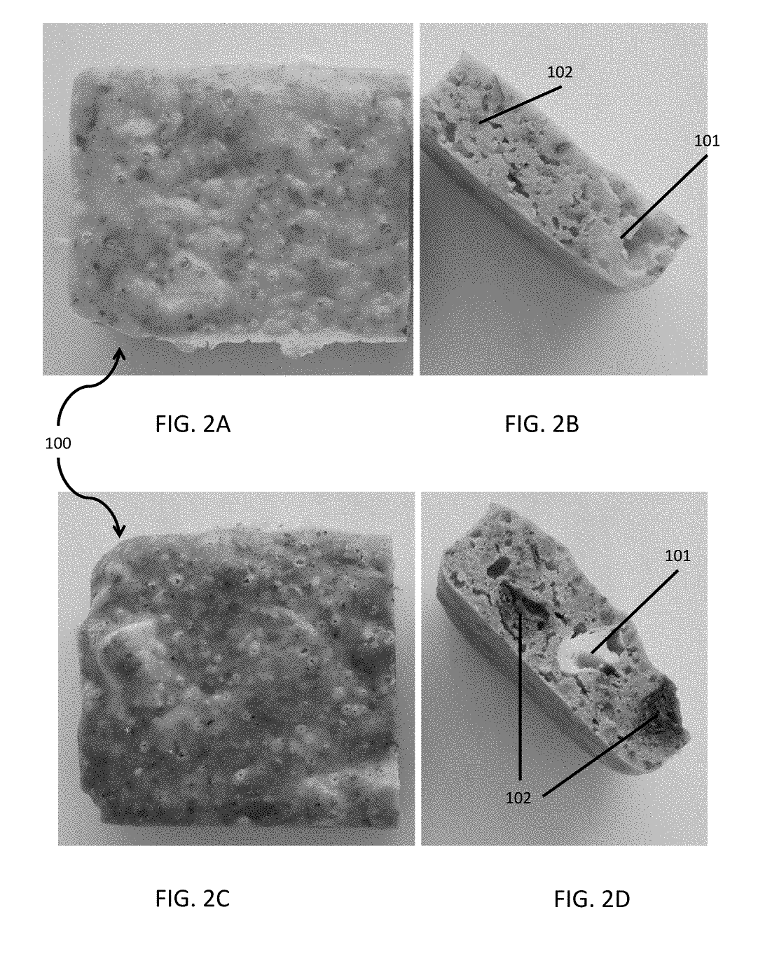

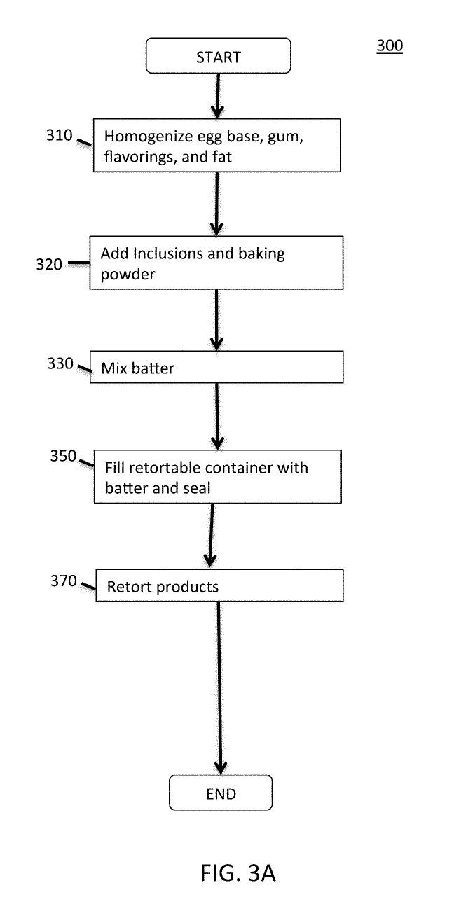

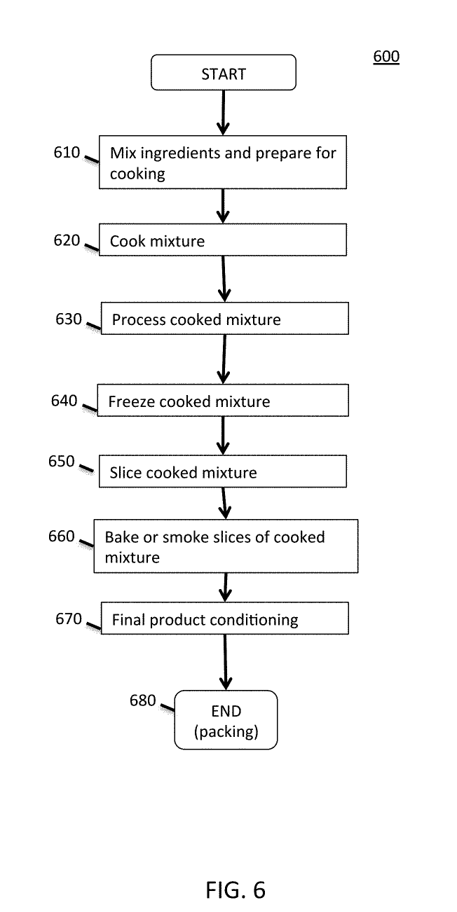

FIGS. 1A-2D and 5A-5B depict examples of shelf-stable egg-based food products 100. In certain embodiments, for example as shown in FIGS. 1A-1D, food product 100 may have a soft, moist, and bready consistency, similar to a muffin. In other embodiments, for example as shown in the example of FIGS. 2A-2D, food product 100 may have a denser, but soft and somewhat crumbly consistency. A crumbly consistency may be characterized by fractures food product into greater than two segments during each bite of mastication. In yet other embodiments, for example, as shown in FIGS. 5A and 5B, food products 100 may have a harder, crunchy consistency.

The food products 100 depicted in in FIGS. 1A-1B and 2A-2B substantially consist of an egg base, bacon, ghee (clarified butter), and cheddar cheese. As may be observed, the cheese may be in the form of pocketed cheese domains 101 and the bacon may be in the form of morsels 102. Similarly, food products 100 depicted in in FIGS. 1C-1D and 2C-2D substantially consist of an egg base, chorizo sausage, ghee, and queso fresco. Here, also the cheese may be in the form of pocketed cheese domains 101 and the sausage may be in the form of morsels 102. Egg-based food products 100, such as those depicted, may be manufactured using baking powder, flavorings, water, hydrocolloids, and/or acids to may improve taste, structure, and/or shelf stability, as further described below. Egg-based food products 100, including those depicted, may further include baking powder, flavorings, water, hydrocolloids, and/or acids to may improve taste, structure, and/or shelf stability, as further described below.

Methods of manufacturing food product 100 have been developed to account for often-competing demands of taste, structure, manufacturing efficiency, and shelf stability. Structure may refer to a food products' level of homogenization, perceived moisture content; perceived softness or hardness; perceived crunchiness, crumbliness, or chewiness; perceived density; structural integrity; and/or the like. Shelf stable foods are generally understood to substantially avoid the undesirable growth of microbes without refrigeration.

As is known in the art, shelf stability may be attained by heating or cooking a food product until its water activity is below a certain threshold. This, however, may imbue the food with one or more undesirable structure characteristics, such as a dry mouth feel or hardness. Furthermore, egg-based proteins may be denatured by heating, but the nature of such denaturation—and thus resulting egg-based product structure—may be influenced by the temperature and duration of such heating.

It is also known that shelf stability may be achieved, at least in part, by achieving a low food product pH combined with pasteurization. While adding acid to a food product during manufacture may improve its shelf stability, such an addition can impart a sour flavor or other undesirable taste or structural characteristic.

Egg Base

Prior to cooking, an egg base may comprise whole eggs in liquid form; egg whites and/or egg yolks in liquid form; whole powdered eggs; powder egg whites; water; other dry protein powders, such as whey or soy; and/or any suitable egg substitute known in the art. In some preferred embodiments, the ultimate ratios of egg white solids to egg yolk solids are not that typically found in a fresh whole egg. Liquid egg components may or may not be processed or pasteurized prior to their use in the manufacturing of food products 100. This is because heating and/or acidulation steps discussed below may serve a sufficient pasteurization function.

In preferred embodiments, as discussed below, the egg base may be prepared from both liquid egg and powdered egg products. The inventors have discovered that the ratio of egg white and egg yolk solids, among other factors, has a profound influence on the structure of food product 100. Such a result was unexpected, particularly as the creation of a moist, soft, and shelf-stable egg-based food product remained elusive when a ratio of egg white and egg yolk proteins similar to those naturally occurring in eggs was used.

Ultimately, it has been empirically determined that a ratio of egg white solids to egg yolk solids of between 2.5:1 and 4.5:1 was very likely to result in a shelf-stable egg-based food product 100 with desirable structural properties. Embodiments of the present disclosure may have a ratio of egg white solids to egg yolk solids of between 2.25:1 and 4.75:1. More specifically, where food product 100 is manufactured using a retort technique, described below, an optimal egg white to yolk ratio may be between 3.5:1 and 4.5:1. Where food product 100 is manufactured using a high acid pasteurization technique, described below, an optimal egg white to yolk ratio is between 2.5:1 and 3:1. It may be noted that an ordinary egg may have a ratio of egg white solids to egg yolk solids of approximately 2:1. Where the egg white to yolk ratio is too high, the resulting food product 100 tended to be spongy and have a dry mouth feel. As used in this disclosure, spongy may refer to undesirable structural characteristics wherein a food product 100 bears a partial structural resemblance to a plastic kitchen sponge in that it is pliable, but has a tendency to substantially return to its original form after being subject to pressure, making to difficult to chew. Where the egg white solid to egg yolk solid ratio is too low, the resulting food product 100 tended to be insufficiently porous, too soft, and tooth-packing.

It has further been observed that an egg base comprised of liquid egg or liquid egg components without any egg powders may have water content to high to create food product 100 with a sufficiently rigid structure to be eaten as a bar—for example, using either the retort or high acid pasteurization techniques. When the water content is too high, food product 100 may appear to be wet and uncooked. However, higher moisture content in the batter may be associated with a desirably fluffier food product 100. Conversely, where excessive egg solids are used, food product 100 may be dry, spongy, or have other undesirable structural characteristics. Thus, the ratio of water to egg solid ratio also has a profound influence on the structure of food product 100.

Ultimately, it has been empirically determined that ratios of egg solids to water of between 0.45:1 and 0.65:1 were likely to result in a shelf-stable egg-based food product 100 with more desirable structural properties. Embodiments of the present disclosure may have ratios of egg solids to water of between 0.4:1 and 0.7:1. More specifically, where food product 100 is manufactured using a retort technique, described below, an optimal egg solid to water ratio may be between 0.45:1 and 0.6:1. Where food product 100 is manufactured using a high acid pasteurization technique, described below, an optimal egg solid to water ratio may be between 0.5:1 and 0.65:1. It may be noted that an ordinary egg may have a ratio of egg solids to water of approximately 0.24:1.

As would be appreciated by persons of skill in the art, desired ratios can be achieved using at least two of liquid egg, liquid egg white, liquid egg yolk, powder egg, powder egg white, powder egg yolk, water, and other suitable powder preparations. For example, water can be added if such egg-base is too dry, and powder whole egg or powder egg yolk can be added to increase the yolk solid content. In one example, as shown below, a desirable ratio may be achieved using liquid egg and powder egg white. Further, it may be advantageous to predominantly use liquid egg or egg components in assembling the egg base, as egg solids are effectively pre-mixed with water in liquid eggs and this may serve to streamline the manufacturing process.

Inclusions

Food product 100 may include different meats or no meat, different cheeses or no cheese, vegetables, spices and herbs, salts, syrups, sugars, alcohols, and/or other foods or food additives known in the art. Components larger than 1 mm in their longest dimension and which result in visually defined ingredient-rich regions in an otherwise visually homogeneous matrix of egg-based food product 100 may be considered inclusions. Visually defined regions may be understood as those apparent to the naked eye. As a quantitative measure, visually defined regions may be understood as regions with a delta_E(2000) difference of at least 5, at least 6, at least 7, at least 8, at least 9, or at least 10, where delta_E(2000) may be measured, for example, with a Nix sensor and associated software application and platform. For example, pieces of meat, cheese, and vegetables meeting this definition may all be considered inclusions of food product 100. Vegetable powders that may be visually defined in food product 100 but are less than 1 mm in their longest dimension may not be considered inclusions; they may be considered flavorings.

In one experiment, food products 100 were prepared with inclusions as various proportions of total batter weight. It was found that at and above inclusion proportions of greater than 40% by weight, the structure of the food product 100 was adversely affected by certain types of inclusions, such as bacon, cheese cubes, chorizo, and meat crumbles. For example, products with such high proportions of these types of had difficulty rising when the disclosed retort manufacturing technique was used. Other inclusions, such as spinach flakes, tomato flakes, pepper flakes, scallions, and chives only minimally interfered with the structure. However, because such inclusions have strong flavor characteristics, it may be preferred that they comprise no more than 20% of food product 100 weight prior to cooking

Different meats may include, but are not limited to, any suitable preparation of pork, beef, lamb, chicken, fish, or the like, or combination thereof. For the purposes of this disclosure, meat substitutes, such as, for example, tofu or vegetarian sausage products, may be also considered meats. In preferred embodiments, the meat may be in the form of morsels 102. In preferred embodiments, each dimension of a meat morsel 102 may be between 2 mm and 5 mm, though larger and smaller morsels 102 are contemplated.

Vegetables may include, but are not limited to, broccoli, kale, tomato, eggplant, garlic, herbs, mushrooms or other edible fungi, and the like, as well as various fruits, such as apples. In preferred embodiments, vegetables may be in the form of morsels 102. Similarly, in preferred embodiments, each dimension of a vegetable morsel 102 may be between 2 mm and 5 mm, though larger and smaller morsels 102 are contemplated. For example, vegetable pieces of herbs, garlic, onion, or the like may have one or two dimensions smaller than 2 mm.

Cheeses may include, but are not limited to, common cheeses such as cheddar, pepper jack, mozzarella, gouda, feta, muenster, and parmesan; high melt cheese varieties, such as high melt cheddar; and cheeses made with an acid process, such as Haloumi, and Paneer. High melt and acid process cheeses advantageously denature at higher temperatures than other types of cheese and therefore may be cooked at higher temperatures and, perhaps, for longer times, without reducing product quality and keeping pieces of the cheese intact. This may be particularly advantageous when food product 100 is prepared using a baking or smoking method disclosed below.

In preferred embodiments, cheese may be in the form of pocketed cheese domains 101. Pocketed cheese domains 101 are depicted, for example, in FIGS. 1A, 1B, 1D, 2B, and 2D, and may comprise a discrete piece of cheese within food product 100. As may be observed, for example, in FIGS. 1B and 1D, pocketed cheese domains 101 may include gaps or air bubbles generated during manufacturing.

In preferred embodiments, as further discussed below, pocketed cheese domains 101 may be included in food product 100 by mixing in a plurality of pieces of cheese into an already-homogenized batter. To facilitate efficient manufacturing, the pieces of cheese may be prepared in cube form, but this disclosure is not so limited. In various embodiments, the pieces of cheese may approximate dimensions of cubes with 1 mm-13 mm sides. More specifically, the preferred range of side dimensions is between 2 mm and 8 mm.

In one experiment, cheese was added at a level of 10-25% at sizes between 1 mm and 8 mm at the shortest side. The higher levels of cheese at the lower particle sizes melted completely into the egg matrix, resulting in an undesirable spongy structure. Also, when a retort technique was used, the higher levels of cheese at the larger particle sizes hindered the rise of the food product 100.

Further, it has been observed that, when the size of cheese pieces is too large, food product 100 may suffer from, for example, irregularities in heat distribution during heating. In turn, this may undermine the product quality or shelf-stability of food product 100. On the end hand, where cheese pieces are too small, the cheese may substantially melt or dissolve into the homogenized egg base during heating, eliminating or reducing the number of and/or discreteness of pocketed cheese domains 101. As such, shredded cheese is unlikely to result in pocketed cheese domains 101. Moreover, it may negatively affect the structure of food product 100. Thus, while the use of shredded cheese is within the scope of embodiments contemplated in this disclosure, some preferred embodiments may omit it.

In various embodiments, food products 100 may contain different percentages inclusions. For example, in preferred embodiments, egg-based food product 100 may contain 55-60% egg base (including water) by weight prior to cooking. In other embodiments, for example, if a substantial amount of inclusions are included, egg-based food product 100 may contain 45-55% egg base by weight prior to cooking. Preferably, egg-based food product 100 may comprise 5-45% inclusions by weight prior to cooking. It may be noted that use of higher proportions of inclusions may adversely affect the structure of food product 100, for example by hindering the rise of the batter during manufacturing via retort techniques.

In other embodiments, for example, if less or no inclusions are included, the egg-based food product may contain 55-60%, 60-65%, 65-75%, 75-80%, 80-85%, 85-90%, or even 90-95% egg base by weight prior to cooking.

Hydrocolloids

Hydrocolloids may included in food product 100 in both retort manufacturing methods and high acid pasteurization manufacturing methods. The inclusion of hydrocolloids has been discovered to improve the structure of food product 100 when using such methods. In the absence of hydrocolloids, higher levels of egg solids were required to maintain structural integrity of the product in bar form. However, products 100 with high levels of egg solids had an undesirable dry and spongy structure. By including hydrocolloids in the egg matrix, the unexpected result of a softer and less dense, but still firm and structurally stable food product 100 was achieved, and, further, was advantageously achieved at a reduced manufacturing cost. It is submitted that such a result was unexpected because egg proteins are very complex structures that have unpredictable interactions with hydrocolloids because the egg proteins themselves play a role that cannot be ignored.

In developing the retort technique, many hydrocolloids were tested in formulation from 0.1% to at least 2.0% to achieve the desired texture and structure—including Xanthan gum, guar gum, konjac flour, carboxyl methyl cellulose, methyl cellulose, and alginate. Konjac flour was tested because of its ability to work well as a fat memetic and to provide structure, which could potentially improve a product's flavor profile and mouth feel. Konjac flour was rejected because it resulted in a product with a slimy mouth feel. Guar gum was found to be suitable, but resulted in a food product 100 that was denser than desired. Xanthan gum at between 0.15% and 2.0% by weight prior to cooking was empirically determined to result in food products 100 with desirable structural characteristic. The inclusion of Xanthan gum in such proportions improved batter viscosity, helped the batter rise during heating before egg protein were fully denatured, and helped maintain structural integrity with a lower percentage of egg white solids, permitting a softer food product 100. In preferred embodiments, food product 100 may include Xanthan gum at between 0.2%-1.0% by weight prior to cooking, with Xanthan gum optimally included at approximately 0.6%.

In developing the high acid pasteurization technique, many hydrocolloids were tested in various formulations. However, in addition to structural characteristics, mitigation of the sourness resulting from a low pH evolved as a major consideration. In order to reduce the sourness of the resulting product, hydrocolloids such as xanthan gum, kappa-carrageenan, guar gum, pectin and carboxymethyl cellulose were investigated at concentrations between 0.2 to 2%. These hydrocolloids were selected based on their application in beverages to attenuate sourness. Konjac flour has not been studied in its ability to reduce perception of sourness, but was tested in this study because of its ability to increase viscosity and impart a moist mouth feel. Of the tested hydrocolloids, the two that were the most effective at reducing the perception of sourness were konjac flour and guar gum in proportions of 1% each, respectively. Ultimately, a combination of guar gum and konjac flour, each at 1%, was empirically determined to result in maximum possible sourness attenuation with the minimum usage amount of hydrocolloids. Such a result was unexpected because the combination of guar gum and konjac flour was more effective than either gum alone, because konjac flour is not known for have sourness attenuation properties, and because konjac flour is not commonly used in solid foods. In preferred embodiments, food product 100 may include konjac flour at between 0.25% and 5.0% and guar gum at between 0.25% and 3.0% by weight prior to cooking.

Fat

One or more fat may be included in the batter of food product 100 to make impart a rich flavor and apparent moisture. In preferred embodiments, the included fat may be a saturated fat, which, for the purposes of the disclosure may be understood as a fat composition with more than 50% saturated fatty acids. This is because saturated fat is less likely than unsaturated fat to leak out of the egg protein matrix and result an undesirable greasy structural characteristics. In preferred embodiments, saturated clarified butter may be included as a fat in food product 100. In clarified butter, milk proteins and water content are removed; this may make later manufacturing processes more efficient as such components may adversely affect the structure of food product 100. In alternative embodiments, the saturated fat may be one or more of butter, palm shortening, coconut oil, tallow, bacon fat, or another saturated fat known in the art. It has been empirically determined that inclusion of a fat at between 2%-35% by weight prior to cooking results in a suitable food product 100. While higher fat percentages have been found to improve heating characteristics during manufacture and result in more desirable flavor and mouth feel characteristics, food products 100 with higher fat percentages may be less desirable for health reasons and, consequently, less commercially viable. In preferred embodiments, food product 100 may include a fat at between 5% and 25% of total product weight prior to cooking. Further, an optimal range may be between 10% and 15% by weight prior to cooking.

Baking Powder

Baking powder at a concentration range of between 0.8-1.2% of total product weight may be added in the batter to impart a slightly leavened texture to food product 100. The concentrate may be increased to up to 3% for a very light and fluffier structure. Beyond 5%, baking powder has been found to adversely affect food product 100 by leading to a dry mouth feel and an overly spread out structure.

Acid

Foods with a pH at or below 4.6 and a water activity of above 0.85 AW are considered acidified foods by the FDA and may be considered shelf-stable. As such, a major object of the high acid pasteurization manufacturing technique is to ensure a pH of at or below 4.6. It is submitted that such an approach to creating a shelf stable egg product is completely novel. High acid pasteurization is typically done in fruit jams and jellies, where a low pH may be economically achieved using aggressive acids like citric acid. However, defining an acid that works with the egg matrix was critical to ensure taste is adequate. That is, the wrong acid profile with egg can suggest spoilage and result in an unmarketable product. More important the acid must bind to the matrix, as opposed to release all at once, and therefore be muted.

In preferred embodiments, gluconic acid and/or gluconodelta-lactone may be used to lower the batter to a desired pH, largely because these acids result in less intense sour or tangy taste than other potential candidates, which included acetic, citric, lactic, malic, succinic, ascorbic, fumaric, and benzoic acids. It is believed that the size and nature of the gluconic acid helps bind it in the egg matrix better and better moderates the acid related sourness. Moreover, most other studied acids resulted in food products 100 with an intense sourness of an unpleasant nature.

In other embodiments, lactic acid may be used to lower the batter to a desired pH. Lactic acid also has a relatively low level of sourness. In particular, it may be advantageous to use lactic acid in combination with cheese or other dairy product inclusions that have relatively low internal lactic acid content. Such combinations may hide the sourness imparted by lactic acid.

Food Product Versions

In some embodiments, food products 100 may consist of a limited number of ingredients, which may result in simpler ingredient statements on packaging. This may be advantageous for marketing to health-conscious consumers. In some embodiments, food products 100 may consist of less than 20, less than 15, less than 10, or less than 5 ingredients, which may preferably be “whole food” ingredients.

By way of non-limiting examples, various versions of food products 100 may have substantially the following inclusions (1) steak, pepper (the vegetable), and onion; (2) Canadian bacon (or breakfast sausage or another type of bacon), maple syrup, and bok choy; (3) smoked salmon, cream cheese, & tomato; (4) feta cheese, spinach, and tomato; (5) chicken sausage, and gouda; (5) turkey bacon, artichoke, goat cheese, and pine nuts; (6) chorizo, tomato, onion, jalapeno, and cilantro; (7) bacon and cheddar cheese; or (8) sun-dried tomato, spinach, and red bell pepper. In some embodiments, food products 100 may be entirely or partially limited to natural and/or organic ingredients. Food products 100 may also, in some embodiments, be low-sodium or sodium free.

In preferred embodiments, Food product 100 may be completely or substantially free of carbohydrates and/or sugars, which are commonly found in conventional snack foods. For example, certain embodiments may have no added carbohydrates but include only de minimis levels of carbohydrates present in other ingredients, such as vegetables.

In alternative embodiments, however, food products 100 may include a carbohydrate to effectuate a crunchier texture. For example, such a carbohydrate may be a starch, such as, corn starch, potato starch, glutinous rice flour, long grain glutinous rice, maple syrup, sugar, or other starch or simple carbohydrate capable of improving crunch as known in the art. In yet other embodiments, food products 100 may include a starchy vegetable, such as potato or yam, or a sweet fruit as an inclusion, thereby increasing carbohydrate content. In yet other embodiments, food products 100 may be sweetened with fruit juice, honey, monk fruit, Stevia, or other form of sugar or sweetener known in the art. As such, in various embodiments, food products 100 may be >99.9%, >99.5%, >99%, >98%, >97%, >96%, >95%, >90%, >80%, >70%, >60%, or >50% carbohydrate free.

Retort Manufacturing Technique

Denaturation of egg proteins, particularly egg whites, is dependent on heat, but the nature of protein denaturation and coagulation is also influenced by shear, moisture content, pH, hydrocolloids, and protein concentrations.

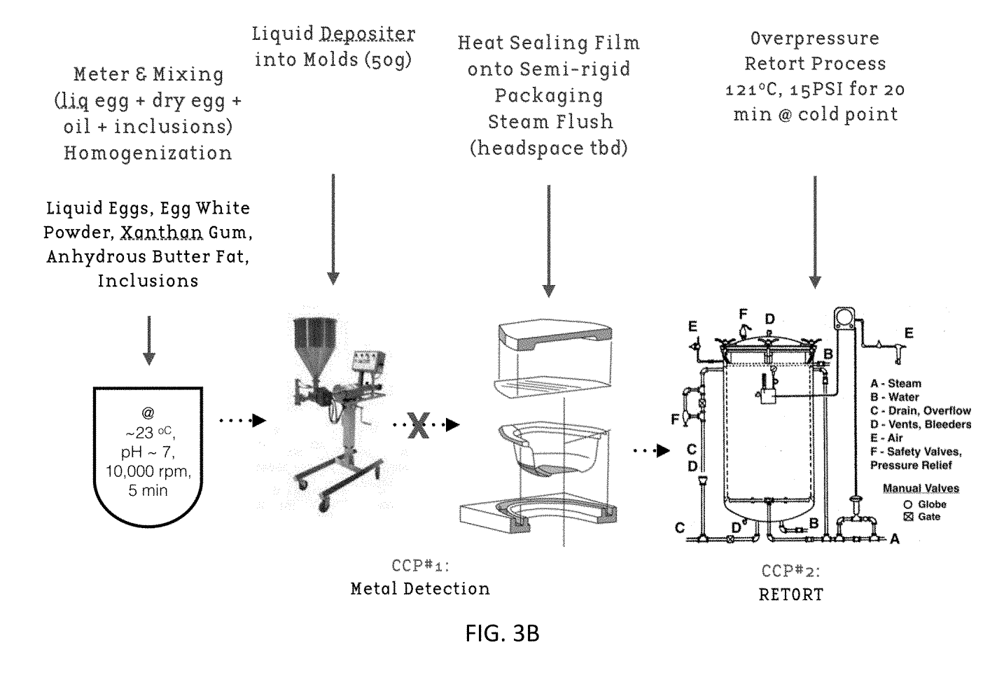

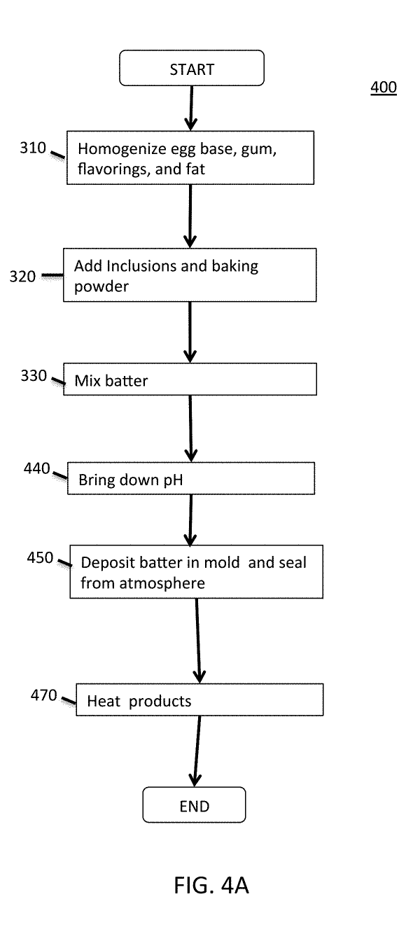

With reference to FIG. 3A, an exemplary process 300 for manufacturing egg-based food product 100 using a retort technique is disclosed. A similar process is disclosed in FIG. 3B. The following is an exemplary, non-limiting ingredient list that may be used to create a 102.95 g batch of egg-based food product 100, as depicted in FIGS. 1A and 1B, via process 300 or the like. As would be understood by persons of skill in the art, the ingredient list may be scaled to accommodate larger batch sizes.

| | | |
|---|---|---|
| Whole Eggs, Liquid | 50.00 | g |
| Egg White, Powder | 8.00 | g |
| Encapsulated Baking Powder | 0.75 | g |
| Clarified Butter, Unsalted | 9.50 | g |
| Cheddar Cheese | 14.00 | g |
| Cooked bacon morsels | 14.00 | g |
| Salt and other flavorings | 1.40 | g |
| Xanthan Gum | 0.30 | g |
| Water | 5.00 | g |

Process 300 may be used to manufacture an egg-based food product 100 that delivers higher protein content without providing a dry mouth feel. Of note, the above ingredient list embodies an approximate preferred balance of ingredients for the food product 100 to have prime structural characteristics after manufacture through process 300—namely, an optimal perceived moisture content while still having high enough protein density for structural stability via gelation. Ultimately, the process 300 results in a unique structure of egg protein coagulation that resembles a muffin or moist bread. Further, resulting food product 100 may have a desirable puffy, light, and air texture due to the addition of a leaving agent and/or a vacuum effect resulting from the retorting process. In some embodiments, its structure may be characterized as a moist, open-style foam.

As in step 310, a homogenization process occurs. This process creates a batter. In this step, the egg base, hydrocolloids, fat, and sometimes flavorings may be homogenized. In some embodiments, as in this example, the egg base may further comprise added water. In addition to mixing ingredients, the homogenization step serves to shear the components of the egg base, encapsulating fat, reducing globule size, and forming a homogeneous matrix. The batter may be homogenized to a viscosity of 1,000-200,000 cP. More specifically, where food product 100 is manufactured using a retort technique, an optimal viscosity range may be 15,000-60,000 cP. Where food product 100 is manufactured using a high acid pasteurization technique, an optimal viscosity range may be 10,000-50,000 cP. It has unexpectedly discovered that an egg base composition at viscosities within these ranges results in an egg-based food product 100 with desirable structural characteristics—including apparent moisture, sufficient strength, and softness. For the purposes of this disclosure, viscosity measurements were taken on a Brookfield DV3T rheometer and analyzed using spindle 4. Samples were analyzed at 20° C. in a step-wise fashion at 5, 10, 15, 20, and 25 RPM for 90 seconds at each step.

As would be understood by persons of ordinary skill in the art, desired viscosities may be obtained by scaling homogenization parameters for different batch sizes and different manufacturing constraints. As an example, an optimal viscosity for a batch size of 750 g in a 1.0 L vessel may be achieved by homogenizing the batter for 5 minutes at 10,000 RPM with a homogenizer diameter of 30 mm at 23° C.

In the homogenization process, the ingredients may all be added at once or they may be added gradually. In one embodiment, liquid egg and/or water are added first, followed by egg powders and hydrocolloids, followed by fat. In another embodiment, liquid egg is added first, followed by fat, and then followed by egg powders.

As in step 320, baking power and the inclusions are added to the batter. In some embodiments, some or all flavorings may be added during this step instead of during step 310. In preferred embodiments, baking powder is that final ingredient to be added. Preferably, the baking powder is encapsulated, as such encapsulation is likely to substantially hinder the leavening action of the baking powder at least until the batter is portioned and packaged as in step 350 (and 450).

In alternative embodiments, baking powder may be omitted. In such embodiments, the batter may optionally be infused with nitrogen as a substitute leavening agent.

As in step 330, the batter may be mixed to distribute and incorporate the inclusions and the baking powder.

As in step 350, the mixed batter may be measured into portions, each of which may be deposited into retortable containers and hermetically sealed. In some embodiments, each batter portion may be between 25 g and 75 g, depending on package size. Where a batter portion is too small, there may be a substantial likelihood that the distribution of inclusions will be uneven.

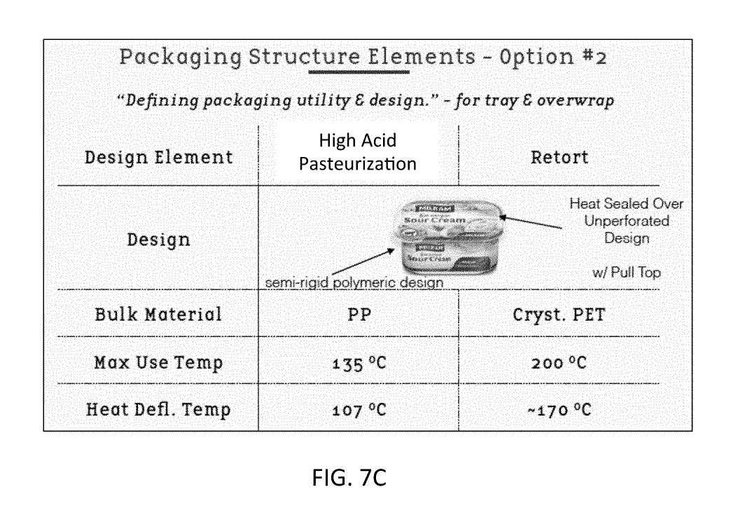

FIGS. 7A and 7B (right side) disclose an embodiment of packaging for food product 100. In this example, a batter portion may be deposited in the tray of FIG. 7A. That tray may be loaded into the enclosure of FIG. 7B, and then hermetically sealed to prevent contamination and permit shelf-stability. This enclosure may serve as the final packaging for an individual food product 100 and may have commercial markings and the like. Advantageously, a tray and enclosure packaging embodiment may separate food product 100 from its outer packaging, making it easier to open and eat. Further, the tray may support and protect the food product 100 from crushing, breaking, bending, squishing, or the like before it is consumed.

FIG. 7C (right side) discloses another embodiment of packaging for food product 100. In this example, a batter portion may be deposited in the cup of FIG. 7C and then sealed with a lid to prevent contamination and permit shelf-stability. The cup and lid may have commercial markings and may serve as the final packaging for an individual food product 100. Advantageously, the cup may support and protect the food product 100 from crushing, breaking, bending, squishing, or the like before it is consumed.

In other embodiments, the retortable container may be a restorable jar, such as a semi-rigid plastic jar (for example, a 4 oz, jar, with a 54 mm bottom diameter and a height of 55 mm), a retortable tray horizontally vacuum sealed into a flexible multi layer film package, a pouch, or any other retortable container known in the art.

It has unexpectedly been discovered that leaving sufficient headspace above the deposited batter within the retortable container may result in improved structural characteristics of fluffiness and low-density during the retorting process. During retorting, the headspace facilitates a vacuum effect that promotes expansion of the batter portion. Specifically, it is believed that the condensation of steam within the container after the retorted product cools down results in a low pressure environment within the sealed container. Thus, where rigid or semi-rigid packaging is used, the batter portion may occupy 35%-75% of packaging by volume. In preferred embodiments, a head space of at least 50% of container volume is provided. For the purposes of this disclosure, a head space may be understood as a pocket of air directly above the batter portion. Certain rigid or semi-rigid retortable containers, such as jars and the cup of FIG. 7C, may be optimal for providing head space. Ultimately, the density of food product 100 may be controlled by adjusting the headspace and the rigidity of packaging. Rigid containers may yield a fully leavened, larger pore, light product; retorting in pouches may yield a denser, micro-porous product.

In some embodiments, the container may be sealed with heat and/or vacuum.

As in step 370, the containers may be retorted using retorting techniques and machines known in the art. It may be efficient to retort multiple containers at the same time. The products may be retorted at between 109° C. and 130° C. at between 24.7 psi and 45 psi for between 15 and 100 minutes. In preferred embodiments, the retort conditions are approximately 30 psi and approximately 121° C. for between 15 and 30 minutes. With retort times exceeding than 30 minutes, only minor textural differences have been observed. With retort times approximating an hour, food product 100 becomes slightly discolored, but is otherwise a viable product. With retort times approximating 100 minutes, the food product 100 is still viable, but its structure has been observed to begin degradation, which is characterized by an increased wetness and a shrinking of food product 100. Thus, retorting times between 15 and 100 minutes may be permissible. In alternative embodiments, food product 100 may be partly cooked via a different method prior to retort.

After step 370, process 300 for manufacturing food products 100 is completed. The products may be inspected for safety and quality and prepared for shipment.

Exemplary embodiments of food products 100 manufactured with process 300 or substantially similar methods may have structural characteristics in the following empirically-determined ranges:
Bulk density: 0.42 g/cc-0.78 g/cc
Moisture Content: 55%-75%
Water Activity: 0.93-0.98 AW
pH: 6.0-8.0

High Acid Pasteurization Manufacturing Technique

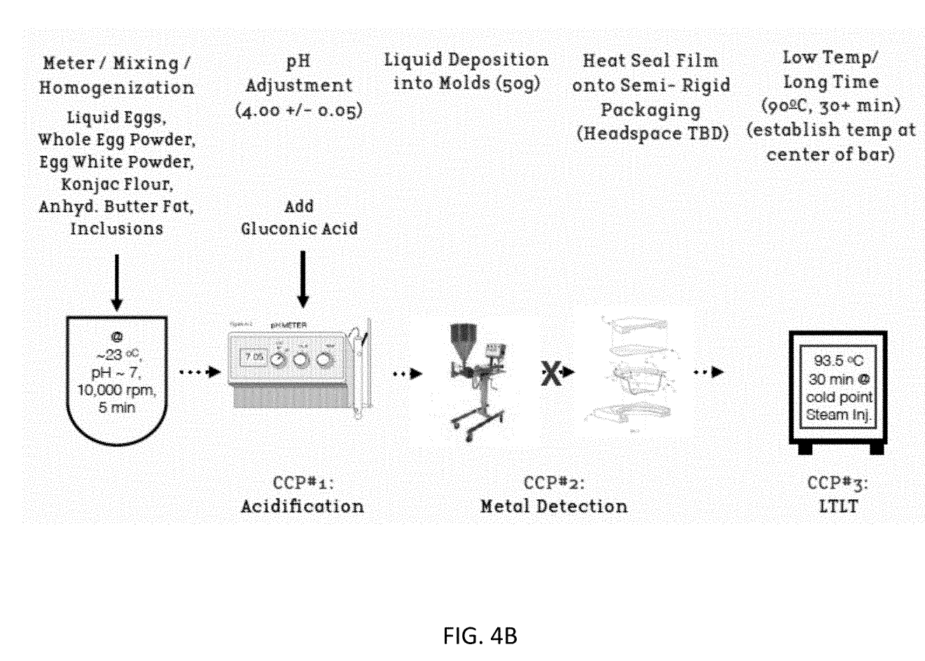

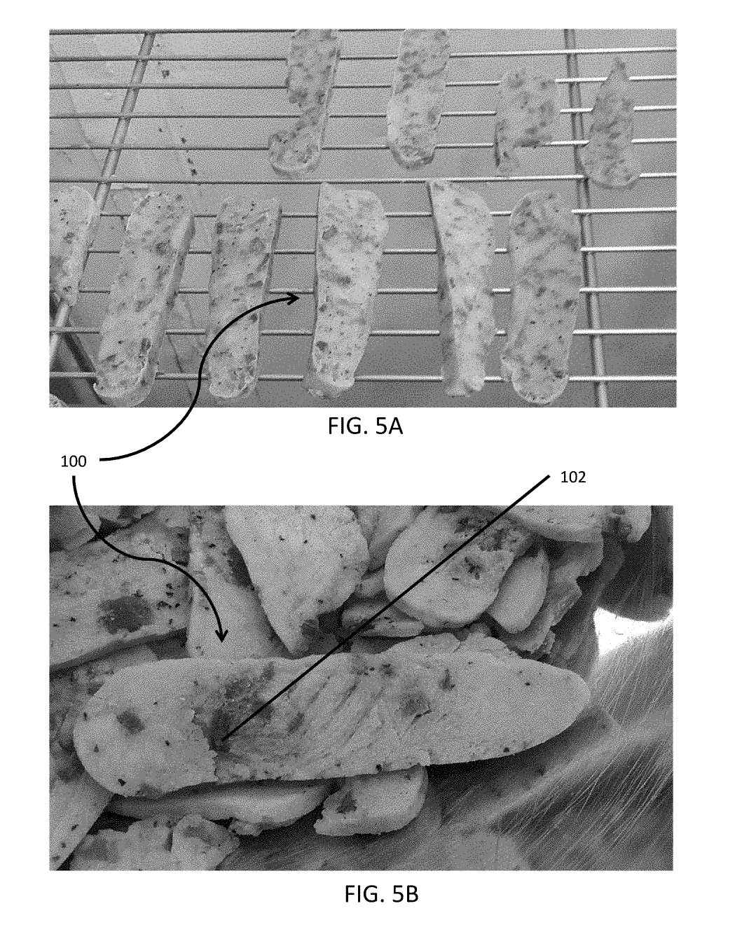

With reference to FIG. 4A, an exemplary process 400 for manufacturing egg-based food product 100 using a high acid pasteurization technique is disclosed. The following is an exemplary, non-limiting ingredient list that may be used to create a 96.45 g batch of egg based food product 100, as depicted in FIGS. 2A and 2B, via process 400 or the like. As would be understood by persons of skill in the art, the ingredient list may be scaled to accommodate larger batch sizes.

| | | |
|---|---|---|
| Whole Eggs, Liquid | 50.00 | g |
| Whole Eggs, Powder | 6.00 | g |
| Egg White, Powder | 3.00 | g |
| Encapsulated Baking Powder | 0.75 | g |
| Clarified Butter, Unsalted | 5.00 | g |
| Cheddar Cheese | 14.00 | g |
| Cooked bacon morsels | 14.00 | g |
| Salt and other flavorings | 2.60 | g |
| Konjac flour | 0.60 | g |
| Guar gum | 0.50 | g |

| | |
|---|---|
| Gluconic Acid | (to arrive at appropriate pH) |

Process 400 may be used to manufacture an egg-based food product 100 that delivers high protein content without providing a dry mouth feel. Of note, the above ingredient list embodies an approximate preferred balance of ingredients for the food product 100 to have prime structural characteristics after manufacture through process 400—namely an optimal perceived moisture content while still having high enough protein density for structural stability via gelation. Ultimately, process 400 may result in a unique structure of egg protein coagulation that resembles crumbliness of cheese, while sustaining softness and integrity in the shape of a bar. This advantageous result was not expected to stem from high acid pasteurization and egg solid balancing. It has been observed that food product 100 resulting from method 400 is denser than that resulting from method 300. However, because the included hydrocolloids lessen the cohesiveness of the egg proteins, the increased density does not result in undesirable structural characteristics like excessive chewiness or hardness.

Steps 310-330 proceed substantially as described in method 300. It may, however, be observed that a greater proportion of salt and other flavorings are included in the sample ingredient list for method 400 compared with the sample ingredient list for method 300. When high acid pasteurization techniques are used, more flavoring may be required to obscure the sourness or tanginess resulting from the low pH of food product 100. Further, because food products 100 manufactured via a retort technique tend to be fluffier and less dense, the impact of the flavorings is stronger due to increased product surface area imbued with the flavorings. In method 400, step 440 follows stem 330.

As in step 440, the pH of the batter is reduced to a pH in the range of 4.0-4.6. In some embodiments, the range may be narrowed to a pH of 4.0-4.1. This may be preferred because, at least for some versions of food product 100, the pH may increase in later steps of process 400. For example, the pH in a bacon and cheddar cheese embodiment of food product 100 has been observed to increase from 4.0 to 4.3 when measured before and after step 470.

As in step 450, the mixed batter may be measured into portions, each of which may be deposited into containers and hermetically sealed. Preferably, each batter is portion between 25 g and 75 g, depending on packaging size. Where a deposited batter portion has a too low surface to volume ratio, there may be a substantial likelihood that the limited heating process of step 470 will be insufficient to cook the egg and kill microbes in innermost portion of the batter portion. Where a batter portion is too small, there may be a substantial likelihood that the distribution of inclusions will be uneven.

FIGS. 7A-7B (left side) and FIG. 7C (left side) disclose embodiments of packaging for food product 100 compatible with this step. In other embodiments, batter may be deposited into a mold of crystallized PET, polypropylene, or the like (for example, of dimensions 4″×2″×0.25″); such a mold may be hermetically sealed in an HPDE pouch or the like.

As in step 470, the containers may be steamed and/or heated using techniques and machines known in the art to complete the pasteurization process. It may be efficient to heat many containers at the same time. The products may be heated at between 90° C. and 100° C. for 30 minutes to an hour. In preferred embodiments, the heating conditions are approximately 93.5° C. for 30-40 minutes.

After step 470, process 400 for manufacturing food products 100 is completed. The products may be inspected for safety and quality and prepared for shipment.

Exemplary embodiments of food products 100 manufactured with process 400 or substantially similar methods may have structural characteristics in the following empirically-determined ranges:
Bulk density: 0.7 g/cc-1.1 g/cc
Moisture Content: 55%-75%
Water Activity: 0.92-0.98 AW
pH: 3.9-4.6

Embodiments of food products 100 manufactured with either process 300, process 400, or the like may preferably have structural characteristics in the following empirically-determined ranges:
Bulk density: 0.42 g/cc-1.1 g/cc
Moisture Content: 55%-75%
Water Activity: 0.92-0.98 AW

Baking or Smoking Manufacturing Technique

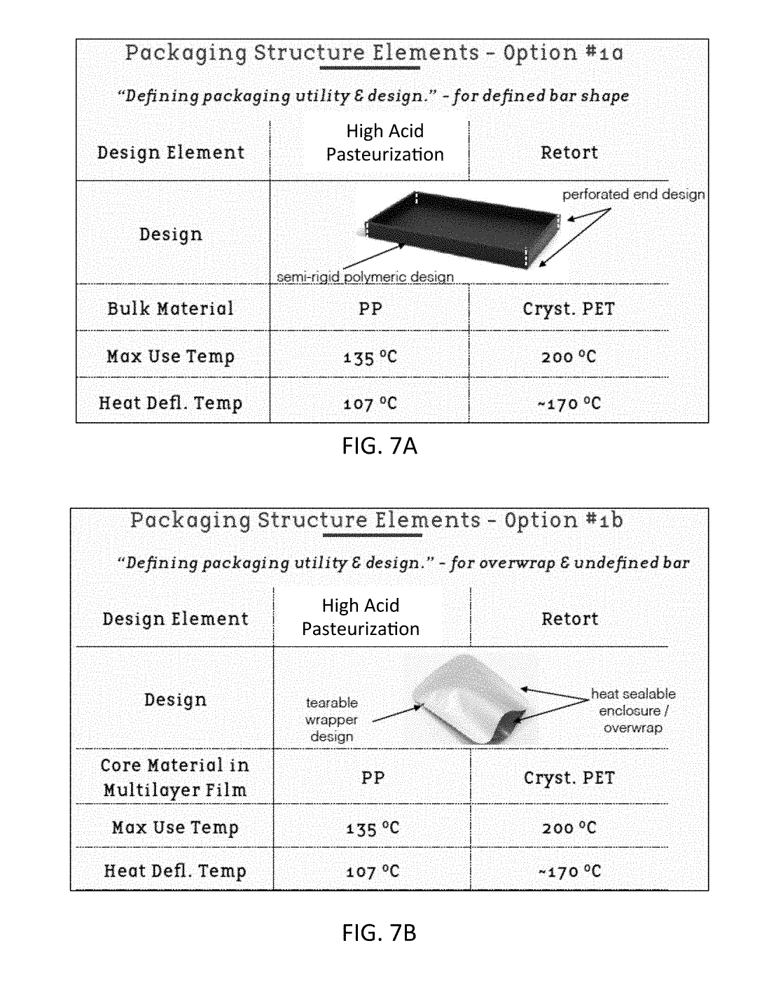

With reference to FIG. 6, an exemplary process 600 for manufacturing egg-based food product 100 using a baking or smoking technique is disclosed. Such technique may be used to manufacture crunchy food products 100, for example as shown in FIGS. 5A and 5B.

As in step 610, the ingredients are mixed and prepared for cooking. As discussed above, such ingredients may include liquid or powdered egg or egg components, melted clarified butter or another oil or rendered fat, and some or all of meat morsels, vegetable morsels, flavorings, stabilizer gum, and/or other ingredients.

At the time of ingredient mixing, the various ingredients may be raw or pre-processed. Preferably vegetable or meat morsels 102 will be pre-cooked or dehydrated. For example, vegetable(s) could have been previously baked, broiled, sun-dried, freeze-dried, grilled, smoked, fried, pickled, or the like. Additionally, certain vegetables known for their flavoring properties, for example, garlic and onion, may be added raw, for example, after being chopped; after being cooked; or in a dried and/or powdered or liquid extract form, for example in an oleoresin form. In alternative embodiments, pieces of raw, whole vegetable, such as tomato, could be mixed in. Similarly, meat morsels may be already cooked, dehydrated, and/or in a more heavily processed form such as pepperoni. In some embodiments, for example, where it can be ensured that meat products will be shelf stable after the baking process, meat morsels may be mixed in raw or partly cooked.

The ingredient mixture may be placed in a boil bag for cooking. Rectangular boil bags may be used. In such circumstances, it may be advantageous to add a stabilizer gum, such as, but not limited to, Pre-Hydrated® Stabilizer XC-8444 Powder, Pre-Hydrated® Stabilizer OG XC-8444 Powder, Pre-Hydrated® Ticaxan® Rapid NGMO, and Pre-Hydrated® Ticaxan® Rapid NGMO-3, which are manufactured by TIC® Gums, to create a suspension of the ingredients in the mixture. This may prevent heavier ingredients from settling the bottom of the bag and/or lighter ingredients from floating to the top of the bag before the egg hardens during the cooking process. Other suspension creating techniques and materials known in the art may alternatively be used. In alternative embodiments, for example if layers with varying ingredient distributions are desired, a stabilizer gum may be omitted.

As in step 620, the mixture may be cooked. In some embodiments, the mixture is cooked via a process similar to that used to cook deli meats such as roast beef, pastrami, or corned beef. Here, a mixture-filled boil bag may preferably be cooked in a hot water bath until the egg base at least partially hardens. The hot water bath may be at a temperature less than water's boiling point (212° F.) during cooking, for example 160-170° F. And, cooking may take several hours to complete.

Optimal hot water bath temperature ranges and cooking times may vary with the thickness and volume of the boil bags, the ingredients being used, whether and how such ingredients are pre-cooked and/or dried at the time of mixing, the ratios of those ingredients, and/or other factors that would be known in the art. For example, thicker or larger boil bags, uncooked ingredients, and higher-density ingredients, may require more heat exposure. Additionally, the melting point of certain ingredients, such as cheeses, is an additional consideration: Heating a cheese beyond its melting point may result in undesirable food quality characteristics in final product, such as greasiness or crustiness. Further, excessively heating cheese pieces may preclude or hinder the formation of pocketed cheese domains 101. Higher temperature baths may result is shorter cook times and vice versa. Ultimately, exemplary temperatures and cook times for various factor combinations may be experimentally determined, by, for example, repeatedly checking whether egg has hardened. For example, whether egg has sufficient hardened may be determined by observing the pressure resistance of the mixture-filled bag, such as manually by hand or by using a machine. In other embodiments, a pressurized heat bath may be used to shorten cooking times.

As in step 630, the cooked mixture may be processed by mixing and/or pressing. In some embodiments, a mixing process may be utilized because the entirety of ingredient mixture may not be fully cooked after step 630. This may occur where, for example, the mixture is cooked in larger bags, such as CHUBB® plastic bag tubes, causing the mixture in the center of the bags to be fully or partially undercooked. By remixing the mixture in step 630, the likelihood of the partially undercooked mixture portion liquefying if it becomes semi-frozen during slicing step 260 is substantially reduced. It may be expected that any partially undercooked mixture portion will finish cooking during baking or smoking step 260 (and/or step 270 in some embodiments).

Further, mixing in step 630 may serve to redistribute solid ingredients within a cooked or partially cooked mixture. Adding a mixing step may assist in manufacturing food products 100 with uniformly distributed ingredients while omitting a stabilizer gum.

In some embodiments of step 630, the mixture may be pressed after re-mixing or even without remixing This may serve to reshape the mixture to facilitate subsequent freezing in step 640 and slicing in step 650. Whether or not the mixture is remixed, pressing may be utilized to reduce the water content of the mixture, thereby potentially lessening the required baking or smoking time or temperature in step 660. In some embodiments, the mixture may be pressed into a mold, which may ultimately cause the resulting food products 100 to have a more uniform shape upon slicing in step 650.

In alternative embodiments of step 630, the mixture may be pressed using sausage-making equipment and stuffed into collagen bags or the like. Then, the sausage-shaped mixture may be frozen (step 640), sliced (step 650), and smoked (step 660). Here the slices may be of a more uniform, circle shape.

In certain embodiments, step 630 may be omitted entirely and method 600 may proceed directly from step 620 to step 640.

As in step 640, the cooked mixture may be frozen. In some embodiments, cooked mixture-filled bags may be first cooled by, for example, being placed in an ice bath, and then may be frozen solid in a freezer. In other embodiments, the cooling step may be omitted. In yet other embodiments, cooked mixture-filled bags may be flash frozen.

As in step 650, the frozen, cooked mixture is cut into pieces. Preferably, it is cut into thin slices. Where a container, such as a boil bag is used in previous steps, such container may be removed from around the mixture before slicing occurs. In some embodiments, slicing is effectuated using a deli meat slicer or another industrial meat slicer. In various embodiments the sliced pieces may have thicknesses of 1″-1.5″, <1″, <0.75″, <0.67″, <0.6″, <0.5″, <0.4″, <0.33″, <0.3″, and/or <0.25″. A relatively uniform thickness amongst slices in a batch may be desired for a more uniform product. Thinner slices may result in crispier food products 100 and/or reduced cooking/smoking in step 260. Thicker pieces may have more structural stability. The slices may be placed on a wire rack. In some embodiments, the sliced pieces may be allowed to thaw before step 660. The sliced pieces may be treated to improve crunchiness prior to the next step; for example, a fine spray of gum arabic solution, for example, TIC Pretested® Gum Arabic FT Powder and/or Ticaloid® 710H Powder from TIC® gums, may be atomized upon the slices.

As in step 660, the slices of cooked mixture are baked or smoked. In preferred embodiments, this may be effectuated by inserting racks containing the sliced pieces into carts, and placing such carts in a smokehouse or other large over. In the smokehouse, the slices may be exposed to smoke and thereby may be cooked and dried similarly to beef jerky. In some embodiments, the slices may be smoked at relatively low temperatures, for example below 160 F. However, the cooking temperatures should be understood be high enough to meet FDA standard “kill points” for microbes. The slices may be smoked for a matter for hours, for example, at least three hours, or alternatively at least one hour, at least two hours, at least four hours, or at least five hours. The optimal smoking temperature(s) and smoking time may be experimentally determined, and may depend on the thickness of the slices, the melting points of cheese(s) being used, and the desired crunchiness or chewiness of the final product. In some embodiments, crunchiness and/or crispiness similar to a potato chip, corn chip, rice cake, or pretzel may be achieved. Preferably, the melting points of the included cheese(s) may not be exceed, at least not for a substantial period of time.

Ultimately, the slices may be smoked baked or smoked at least until their water content is reduced below the legal maximum for a product to be deemed shelf-stable, such as 0.85 AW. In some embodiments, the water content may be further reduced to, for example, improve crunchiness or chewiness characteristics of the final product. For example, the slices may be smoked until water content is reduced below 0.80 AW, 0.75 AW, 0.70 AW, 0.65 AW, 0.60 AW, 0.55 AW, 0.50 AW, 0.45 AW, 0.40 AW, 0.35 AW, 0.30 AW, 0.25 AW, 0.20 AW, 0.10 AW, or 0.05 AW. FIG. 5A depicts sliced pieces on a wire rack after the smoking process is completed.

As in step 670, the smoked or baked slices may undergo additional product conditioning to, for example, increase the crunch and/or reduce the water content of the final product. For example, the slices may be quickly fried, baked, or broiled, via conveyor belt or otherwise. In some embodiments, such processes may reduce the water content of the smoked slices below 0.80 AW, 0.75 AW, 0.70 AW, 0.65 AW, 0.60 AW, 0.55 AW, 0.50 AW, 0.45 AW, 0.40 AW, 0.35 AW, 0.30 AW, 0.25 AW, 0.20 AW, 0.10 AW, or 0.05 AW.

In other embodiments, the smoked slices maybe further cooked via patented REV™ technology owned by Enwave Corporation©; this technology may further dehydrate the slices and add additional crunch via a vacuum-microwave process, without denaturing the product.

In yet other embodiments, the final product may be crunchier on the outside and chewier on the inside similar to Moon Cheese™ snack. Where slices undergo additional cooking in step 670, step 660 may terminate before the water content is reduced below the legal maximum for a product to be deemed shelf-stable. This is because water content may be reduced to below the legal maximum in step 270.

In yet other embodiments, step 670 may additionally or alternatively comprise dusting the sliced product with powdered flavorings and/or applying liquid flavorings, such as nutritional yeasts, Edlong liquid or powdered flavorings (butter and cheese flavors); spices, including but not limited to salt, pepper, garlic, paprika, and onion; celery juice or celery juice powder; or the like.

In certain embodiments, step 670 may be omitted entirely and method 600 may proceed directly from step 660 to step 680.

As in step 680, the manufacturing process is completed. As required by law, regulation, or quality control procedures, the completed food products 100 may be tested for water/moisture content/percentage, water activity, moisture protein ratio, or other characteristics. Then, the packing may occur and process 600 is completed. In various embodiments, completed egg-based food products 100 may have thicknesses of 1″ to 1.5″, <1″, <0.75″, <0.67″, <0.6″, <0.5″, <0.4″, <0.33″, <0.3″, <0.25″, <0.2″, <0.1″, <0.075″, <0.05″, and/or <0.025″.

In alternative embodiments of manufacturing egg-based food products 100 via a baking or smoking technique, the ingredient mixture may be through an extruder that cooks (step 620) and then flash freezes (step 640) it. In some alternative embodiments, the mixture may also be puffed during the extrusion process. The cooked and frozen mixture extrusion may be sliced (step 650) and then baked or smoked (step 660). The slicing may occur automatically, with the extrusion and slices being moved via conveyor belt.

Although the foregoing embodiments have been described in detail by way of illustration and example for purposes of clarity of understanding, it will be readily apparent to those of ordinary skill in the art in light of the description herein that certain changes and modifications may be made thereto without departing from the spirit or scope of the appended claims. It is also to be understood that the terminology used herein is for the purpose of describing particular aspects only, and is not intended to be limiting, since the scope of the present invention will be limited only by the appended claims.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation. As will be apparent to those of ordinary skill in the art upon reading this disclosure, each of the individual aspects described and illustrated herein has discrete components and features which may be readily separated from or combined with the features of any of the other several aspects without departing from the scope or spirit of the disclosure. Any recited method can be carried out in the order of events recited or in any other order that is logically possible. Accordingly, the preceding merely provides illustrative examples. It will be appreciated that those of ordinary skill in the art will be able to devise various arrangements which, although not explicitly described or shown herein, embody the principles of the disclosure and are included within its spirit and scope.

Furthermore, all examples and conditional language recited herein are principally intended to aid the reader in understanding the principles of the invention and the concepts contributed by the inventors to furthering the art, and are to be construed without limitation to such specifically recited examples and conditions. Moreover, all statements herein reciting principles and aspects of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary configurations shown and described herein.

In this specification, various preferred embodiments have been described with reference to the accompanying drawings. It will be apparent, however, that various other modifications and changes may be made thereto and additional embodiments may be implemented without departing from the broader scope of the claims that follow. The specification and drawings are accordingly to be regarded in an illustrative rather than restrictive sense.

We claim:

1. A method for manufacturing a shelf-stable food product, comprising:
providing an egg base, the egg base having a first ratio of egg white solids to egg yolk solids within a range of 2.25:1 and 4.75:1;
providing a first hydrocolloid set;
providing a fat;
homogenizing the egg base with at least the first hydrocolloid set and the fat into a batter;
sealing a batter portion of the batter into a container; and
heating the container.

2. The method of claim 1, wherein the step of homogenizing further comprises homogenizing the batter to a viscosity of between 1,000 cP and 200,000 cP.

3. The method of claim 1, further comprising adding a first inclusion to the batter after the homogenizing step.

4. The method of claim 3, further comprising;
providing a plurality of pieces of cheese as the first inclusion, wherein at least one piece of cheese is a size of a 1 mm or greater in each of three spatial dimensions.

5. The method of claim 1, wherein the step of heating the container further comprises:
retorting the container at a pressure between 24.7 and 45 psi at a temperature of between 109° C. and 130° C. for 15-100 minutes.

6. The method of claim 5, wherein the step of sealing a batter portion of the batter into a container further comprises:
providing at least 50% of head space by volume within the container.

7. The method of claim 5, wherein the step of providing a first hydrocolloid set further comprises:
providing a portion of Xanthan gum, wherein the portion is between 0.15% and 2.0% of the batter portion by weight.

8. The method of claim 1, further comprising:
acidulating the batter to a pH of between 4.0 and 4.6 using at least one of gluconic acid, gluconodelta-lactone, and lactic acid.

9. The method of claim 8, wherein the step of heating the container further comprises:
heating the container at a temperature between 90° C. and 100° C. for between 30 minutes and an hour.

10. The method of claim 8, wherein the step of providing a first hydrocolloid set further comprises:
providing a first portion of konjac flour; and
providing a second portion of guar gum, wherein
the first portion is between 0.25% and 5.0% of the batter portion by weight; and
the second portion is between 0.25% and 3.0% of the batter portion by weight.

11. The method of claim 1, wherein the step of providing a fat further comprises:
providing a portion of saturated fat, wherein the portion is between 5% and 25% of the batter portion by weight.

12. The method of claim 1, further comprising
providing a portion of encapsulated baking powder; and
adding the portion into the batter after homogenizing the batter,
wherein the portion is between 0.5% and 3.0% of the batter portion by weight.

13. A shelf-stable food product prepared by a process comprising the steps of:
providing an egg base, the egg base having a first ratio of egg white solids to egg yolk solids within a range of 2.25:1 and 4.75:1;
providing a first hydrocolloid set;
providing a fat;
homogenizing the egg base with at least the first hydrocolloid set and the fat into a batter;
sealing a batter portion of the batter into a container; and
heating the container.

14. A shelf-stable food product, comprising:
an egg base, the egg base having a first ratio of egg white solids to egg yolk solids between 2.25:1 and 4.75:1;
a first hydrocolloid set; and
a fat,
wherein the shelf-stable food product is enclosed with heat resistant packaging.

15. The shelf-stable food product of claim 14, wherein the fat is a saturated fat between 5% and 25% of the shelf-stable food product by weight.

16. The shelf-stable food product of claim 14, wherein:
the shelf-stable food product has a bulk density of between 0.42 g/cc and 1.1 g/cc; and
the shelf-stable food product has a moisture content of between 55% and 75%.

17. The shelf-stable food product of claim 16, further comprising:
a plurality of pocketed cheese domains.

18. The shelf-stable food product of claim 14, wherein:
the first hydrocolloid set comprises a first portion of konjac flour;
the first hydrocolloid set comprises a second portion of guar gum;
the first portion is between 0.25% and 5.0% of the shelf-stable food product by weight; and
the second portion is between 0.25% and 3.0% of the shelf-stable food product by weight.

19. The shelf-stable food product of claim 14, wherein:
the shelf-stable food product has a water activity level of between 0.92 AW and 0.98 AW; and
the shelf-stable food product has a pH level of between 3.9 and 4.6.

20. The shelf-stable food product of claim 14, wherein:
the first hydrocolloid set comprises a portion of Xanthan gum; and
the first portion is between 0.15% and 2.0% of the shelf-stable food product by weight.
